(19) United States
(12) Patent Application Publication
(10) Pub. No.: US 2012/0117310 A1
(43) Pub. Date: May 10, 2012

(54) USB FLASH DRIVE AND METHOD FOR SWITCHING FUNCTIONS OF THE USB FLASH DRIVE

(75) Inventors: MENG LIU, Shenzhen City (CN); GE-XIN ZENG, Shenzhen City (CN)

(73) Assignees: HON HAI PRECISION INDUSTRY CO., LTD., Tu-Cheng (TW); HONG FU JIN PRECISION INDUSTRY (ShenZhen) Co., LTD., Shenzhen City (CN)

(21) Appl. No.: 13/172,841

(22) Filed: Jun. 30, 2011

(30) Foreign Application Priority Data
Nov. 10, 2010 (CN) 201010563794.4

(51) Int. Cl. G06F 12/00

(52) U.S. Cl. 711/103; 711/E12.008

(57) ABSTRACT

A system and a method for switching functions of A Universal Serial Bus (USB) flash drive includes setting a bilateral switch under a first triggered status represents that the USB flash drive is in a boot mode, and under a second triggered status represents that the USB flash drive is in a memory mode. The switching method further includes a determination of whether the USB flash drive is in the boot mode, according to the triggered status of the bilateral switch. The switching method further includes controlling the host controller to access data in a flash memory in the USB flash drive, if the USB flash drive is in the boot mode; or controlling the host controller to access data in a main flash memory section in the flash memory if the USB flash drive is in the boot mode.

### BACKGROUND

1. Technical Field

Embodiments of the present disclosure relate to a Universal Serial Bus (USB), and more particularly to a USB flash drive and method for switching functions of the USB flash drive.

2. Description of Related Art

Generally, a USB flash drive (also known as memory stick, flash memory, thumb drive, etc) can be used as a storage device for storing data, and as a startup disk for installation of an operating system. That is, the USB flash drive function both as a storage device and a startup disk. However, when the USB needs to function as a startup disk from functioning as a storage device, the data in the USB flash drive has to be cleared first, and a startup file of an operating system needs to copied into the USB flash drive. When the function of the startup disk needs to switch to the function of the storage device, specific sections of the USB flash drive need to be cleared to avoid the USB flash drive being considered as a startup option by a computer device. Thus, it is inconvenient to switch the two functions of the USB flash drive, and both data and time may be lost.

### BRIEF DESCRIPTION OF THE DRAWINGS

FIG. 1 is a schematic diagram of one embodiment of a USB flash drive.

FIG. 2 is a block diagram of a host controller in the USB flash drive of FIG. 1.

FIG. 3 is a flowchart of one embodiment of a method for switching the functions of a USB flash drive, such as that of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

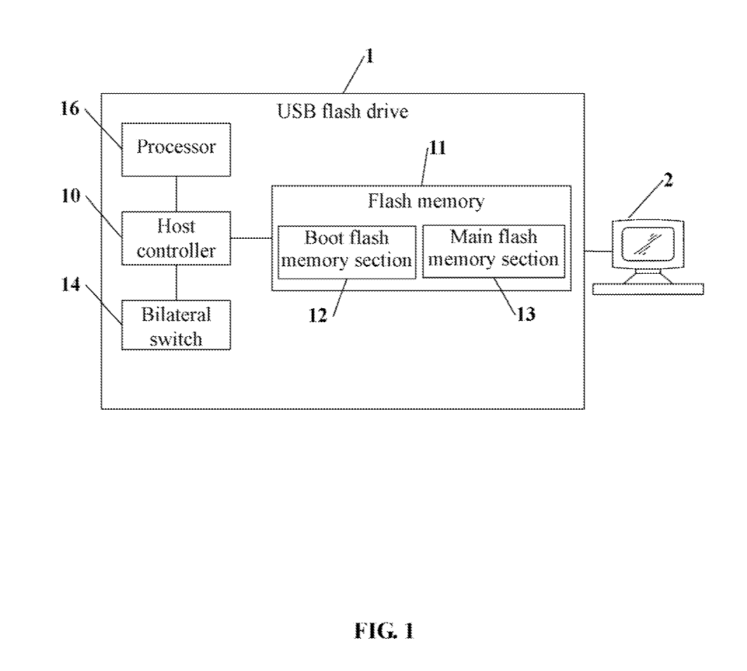

FIG. 1 is a block diagram of one embodiment of a Universal Serial Bus (USB) flash drive 1. The USB flash drive 1 includes a host controller 10, a flash memory 11, and a bilateral switch 14. The USB flash drive 1 is in communication with a computer device 2 through a USB interface (not shown in FIG. 1). When the USB flash drive 1 is connected to the computer device 2, the computer device 2 may send an instruction of reading data in the USB flash drive 1, and may send an instruction to disconnect the USB flash drive 1. The USB flash drive 1 may function as a storage device and as a startup disk. The storage device function and the startup disk function of the USB flash drive 1 may each take the place of the other. Detailed descriptions are provided below.

The host controller 1 may read and write data in the USB flash drive 1. The flash memory 11 stores various data in the USB flash drive 1. In some embodiments, the flash memory 11 includes a boot flash memory section 12 and a main flash memory section 13. The boot flash memory section 12 stores boot files for an installation of an operating system of the computer device 2. The boot flash memory section 12 and the main flash memory section 13 are located in different memory addresses of the flash memory 11. The bilateral switch 14 has a slip key (not shown in FIG. 1). The bilateral switch 14 has two triggered statuses corresponding to two slip positions. If the slip key of the bilateral switch 14 is slid to a first slip position, the bilateral switch 14 is under a first triggered status. If the slip key is slid to a second slip position, the bilateral switch 14 is under a second triggered status. Descriptions of the triggered statuses are provided below.

The USB flash drive 1 further includes at least one processor 16. The at least one processor 16 executes one or more computerized codes and other applications of the USB flash drive 1, to provide functionality to the USB flash drive 1.

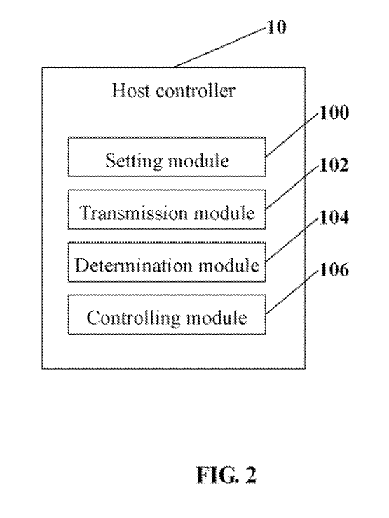

FIG. 2 is a block diagram of one embodiment of a host controller in the USB flash drive of FIG. 1. In some embodiments, the host controller 10 may include a setting module 100, a transmission module 102, a determination module 104, and a controlling module 106. The modules 100, 102, 104, and 106 comprise computerized codes in the form of one or more programs that are stored in the host controller 10. The computerized code includes instructions that are executed by at least one processor 16 to provide functions for the modules 100, 102, 104, and 106. Details of these operations are as follows.

The setting module 100 sets a boot mode of the USB flash drive 1 under the condition that the bilateral switch 14 is under the first triggered status, and sets a memory mode of the USB flash drive 1 under the condition that the bilateral switch 14 is under the second triggered status.

The transmission module 102 receives an instruction to read data in the USB flash drive 1 from the computer device 2, upon the condition that the USB flash drive 1 is connected to the computer device 2.

The determination module 104 determines whether the USB flash drive 1 is in the boot mode, according to a current triggered status of the bilateral switch 14. If the determination module 104 detects that the bilateral switch 14 is under the first triggered status, the determination module 104 determines that the USB flash drive 1 is in the boot mode.

If the USB flash drive 1 is in the boot mode, the controlling module 106 controls the host controller 10 to access data in the flash memory 11 of the USB flash drive 1. Data in both the boot flash memory section 12 and the main flash memory section 13 may be processed, such as reading and writing corresponding data, for example.

If the USB flash drive 1 is not in the boot mode, the controlling module 106 controls the host controller 10 to access the data in the main flash memory section 13 in the flash memory 11, and denies access to data in the boot flash memory section 12. That is, if the USB flash drive 1 is under the memory mode, only the data in the main flash memory section 13 may be processed.

The transmission module 102 further transmits accessed data to the computer device 2.

The determination module 104 further determines whether all the accessed data has been transmitted to the computer device 2. In some embodiments, if the instruction to disconnect the USB flash drive 1 has received from the computer device 2, the determination module 104 determines that all the accessed data has been transmitted to the computer device 2. In other embodiments, the determination module 104 may determine that all the accessed data has been transmitted to the computer device, if volume of transmitted accessed data has reached a predetermined amount or number (e.g., 500 k) before transmission of the accessed data. If the transmission has not finished, the host controller 10 may continue to access data in the USB flash drive 1 according to a current mode of the USB flash drive 1.

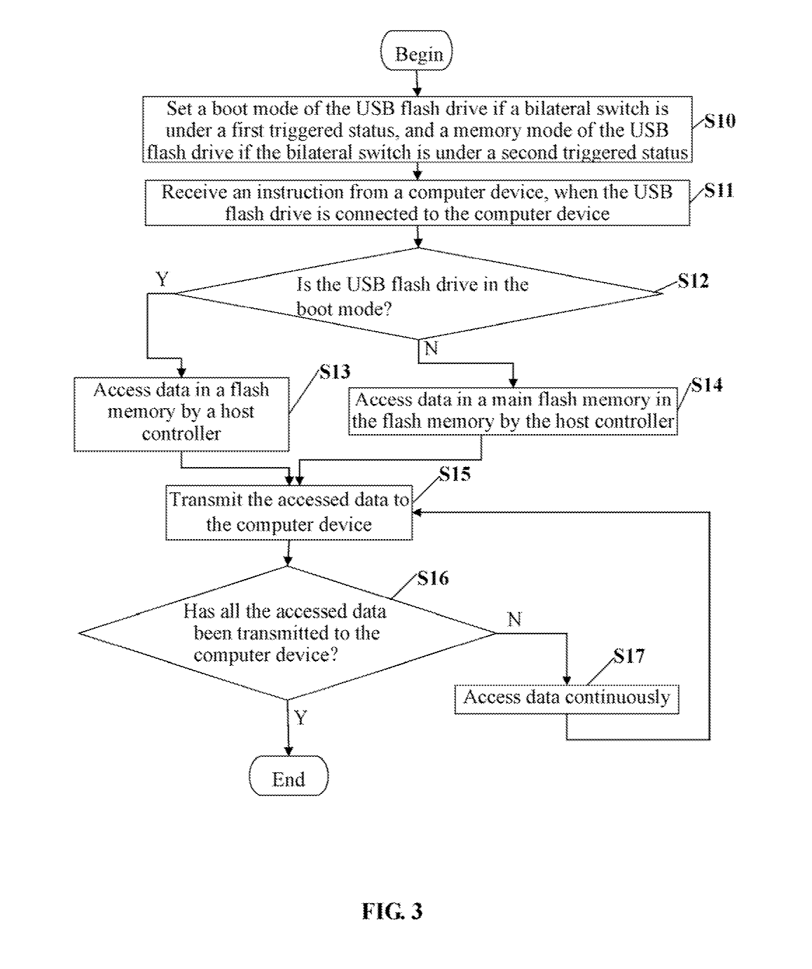

FIG. 3 is a flowchart of one embodiment of a method for switching functions of the USB flash drive, such as, that of FIG. 1. Depending on the embodiment, additional blocks may be added, others deleted, and the ordering of the blocks may be changed.

In block S10, the setting module 100 sets a boot mode of the USB flash drive 1 under the condition that the bilateral switch 14 is under the first triggered status, and sets a memory mode of the USB flash drive 1 under the condition that the bilateral switch 14 is under the second triggered status.

In block S11, when the USB flash drive 1 is connected to the computer device 2, the transmission module 102 receives an instruction from the computer device 2 to read data in the USB flash drive 1.

In block S12, the determination module 104 determines whether the USB flash drive 1 is in the boot mode, according to a current triggered status of the bilateral switch 14. When the determination module 104 detects that the bilateral switch 14 is under the first triggered status, the determination module 104 determines the USB flash drive 1 is under the boot mode. If the USB flash drive 1 is in the boot mode, block S13 is implemented; if the USB flash drive 1 is in the memory mode, block S14 is implemented.

In block S13, the controlling module 106 controls the host controller 10 to access data in the flash memory 11 in the USB flash drive 1, and block S15 is implemented.

In block S14, the controlling module 106 further controls the host controller 10 to access data in the main flash memory section 13 in the flash memory 11, and denies access to data in the boot flash memory section 12.

In block S15, the transmission module 102 further transmits accessed data to the computer device 2.

In block S16, the determination module 104 further determines whether all the accessed data has been transmitted to the computer device 2. The determination module 104 may determine that the all the accessed data has been transmitted to the computer device 2, if an instruction to disconnect the USB flash drive 1 has received from the computer device 2. If all the accessed data has been transmitted to the computer device 2, the procedure is ended.

In block S17, if all the accessed data has not been transmitted to the computer device 2, the host controller 10 may continue to access data in the USB flash drive 1 according to a current mode of the USB flash drive 1, and block S15 is repeated.

It should be emphasized that the described exemplary embodiments are merely possible examples of implementations, and have been set forth for a clear understanding of the principles of the present disclosure. Many variations and modifications may be made to the-described exemplary embodiments without departing substantially from the spirit and principles of the present disclosure. All such modifications and variations are intended to be comprised herein within the scope of this disclosure and the described inventive embodiments, and the present disclosure is protected by the following claims.

What is claimed is:

1. A method of a Universal Serial Bus (USB) flash drive, the USB flash drive comprising a host controller and a bilateral switch, the bilateral switch having a first triggered status and a second triggered status, the method comprising:
setting a boot mode of the USB flash drive under the condition that the bilateral switch is under the first triggered status, and setting a memory mode of the USB flash drive under the condition that the bilateral switch is under the second triggered status;
receiving an instruction of reading data in the USB flash drive from a computer device, upon the condition that the USB flash drive is connected to the computer device;
determining whether the USB flash drive is in the boot mode, according to detecting a current triggered status of the bilateral switch;
controlling the host controller to access data in a flash memory in the USB flash drive, upon the condition that the USB flash drive is in the boot mode; or
controlling the host controller to access data in a main flash memory section in the flash memory, upon the condition that the USB flash drive is not in the boot mode.

2. The method as claimed in claim 1, further comprising:
denying access to data in the boot flash memory section, upon the condition that the USB flash drive is not in the boot mode.

3. The method as claimed in claim 2, further comprising:
transmitting accessed data to the computer device.

4. The method as claimed in claim 4, wherein all the accessed data has been transmitted to the computer device, upon the condition that an instruction to disconnect the USB flash drive has received from the computer device.

5. The method as claimed in claim 2, wherein the bilateral switch having two slip positions, the bilateral switch is under the first triggered status upon the condition that the bilateral switch is slid to a first slip position, and the bilateral switch is under the second triggered status upon the condition that the bilateral switch is slid to second slip position.

6. A storage medium storing a set of instructions, the set of instructions capable of executed by a processor to perform a method for switching functions of a Universal Serial Bus (USB) flash drive, the USB flash drive comprising a host controller and a bilateral switch, the bilateral switch having a first triggered status and a second triggered status, the method comprising:
setting a boot mode of the USB flash drive under the condition that the bilateral switch is under the first triggered status, and setting a memory mode of the USB flash drive under the condition that the bilateral switch is under the second triggered status;
receiving an instruction of reading data in the USB flash drive from a computer device, upon the condition that the USB flash drive is connected to the computer device;
determining whether the USB flash drive is in the boot mode, according to detecting the triggered status of the bilateral switch;
controlling the host controller to access data in a flash memory in the USB flash drive, upon the condition that the USB flash drive is in the boot mode; or
controlling the host controller to access data in a main flash memory section in the flash memory, upon the condition that the USB flash drive is not in the boot mode.

7. The storage medium as claimed in claim 6, further comprising:
denying access to data in the boot flash memory section, upon the condition that the USB flash drive is not in the boot mode.

8. The storage medium as claimed in claim 7, further comprising:
transmitting accessed data to the computer device.

9. The storage medium as claimed in claim 8, wherein all the accessed data has been transmitted to the computer device, upon the condition that an instruction to disconnect the USB flash drive has received from the computer device.

10. The storage medium as claimed in claim 7, wherein the bilateral switch having two slip positions, the bilateral switch is under the first triggered status upon the condition that the bilateral switch is slid to a first slip position, and the bilateral switch is under the second triggered status upon the condition that the bilateral switch is slid to second slip position.

11. A Universal Serial Bus (USB) flash drive, comprising:
a host controller;
a bilateral switch having a first triggered status and a second triggered status;
at least one processor;
one or more programs that are stored in the storage system and are executed by the at least one processor, the one or more programs comprising:
a setting operable to set a boot mode of the USB flash drive under the condition that the bilateral switch is under the first triggered status, and set a memory mode of the USB flash drive under the condition that the bilateral switch is under the second triggered status;
a receiving module operable to receive an instruction of reading data in the USB flash drive from a computer device, upon the condition that the USB flash drive is connected to the computer device;
a determination module operable to determine whether the USB flash drive is in the boot mode, according to detecting the triggered status of the bilateral switch;
a controlling module operable to control the host controller to access data in a flash memory in the USB flash drive, upon the condition that the USB flash drive is in the boot mode;
the controlling module further operable to control the host controller to access data in a main flash memory section in the flash memory, upon the condition that the USB flash drive is not in the boot mode.

12. The USB flash drive as claimed in claim 11, wherein the controlling module further operable to deny access to data in the boot flash memory section, upon the condition that the USB flash drive is not in the boot mode.

13. The USB flash drive as claimed in claim 12, wherein the one or more programs further comprises a transmission module operable transmit accessed data to the computer device.

14. The USB flash drive as claimed in claim 13, wherein the determination module further operable to determine that all the accessed data has been transmitted to the computer device 2, upon the condition that an instruction to disconnect the USB flash drive has received from the computer device.

15. The USB flash drive as claimed in claim 12, wherein the bilateral switch having two slip positions, and the bilateral switch is under the first triggered status upon the condition that the bilateral switch is slid to a first slip position, and under the second triggered status upon the condition that the bilateral switch is slid to second slip position.
